(19) United States
(12) Patent Application Publication
(10) Pub. No.: US 2013/0262725 A1
(43) Pub. Date: Oct. 3, 2013

(54) DATA PROCESSING DEVICE AND METHOD FOR CONTROLLING DATA PROCESSING DEVICE

(71) Applicant: FUJITSU LIMITED, Kawasaki-shi (JP)

(72) Inventors: Toshiro ITO, Kawasaki-shi (JP); Yasunobu AKIZUKI, Kawasaki-shi (JP)

(21) Appl. No.: 13/737,135

(22) Filed: Jan. 9, 2013

(30) Foreign Application Priority Data
Mar. 28, 2012 (JP) 2012-073990

(51) Int. Cl. G06F 13/364

(52) U.S. Cl. CPC G06F 13/364
USPC 710/113

(57) ABSTRACT

A data processing device includes a plurality of entries and a plurality of output ports, allocates the plurality of entries to a plurality of arbitration groups corresponding to the plurality of output ports respectively when a clock is inputted thereto, arbitrates the output ports for each of the allocated arbitration groups when data held in the entry is outputted from the output port, and outputs data held in the entry according to an arbitration result.

### CROSS-REFERENCE TO RELATED APPLICATION

This application is based upon and claims the benefit of priority of the prior Japanese Patent Application No. 2012-073990, filed on Mar. 28, 2012, the entire contents of which are incorporated herein by reference.

### FIELD

The embodiments discussed herein are directed to a data processing device and a method for controlling the data processing device.

### BACKGROUND

A processor generally has a data buffer in its instruction issue unit. For example, in a processor performing out-of-order execution of instructions in which execution is started from an instruction for which data required for arithmetic processing is ready regardless of the order of instructions described in a program, a reservation station that is a kind of a priority queue is used as the data buffer. A basic function of the reservation station is detection of instructions satisfying issue conditions, performance of arbitration among the issuable instructions, and issue of the instructions to an arithmetic unit connected to an output port. The buffer having a function similar to the reservation station is also called, for example, an instruction issue queue, an instruction scheduler, or, more abstractly, an instruction window.

Examples of the priority decision system for the arbitration of the output port of the priority queue include a bubble-up system (also called a shifting queue, a compacting scheduler or the like), and a system using a precedence matrix (also called an age matrix or the like) indicating the relationship of priority order. Here, the bubble-up system is a system of a buffer in which when the priority order of each entry is fixed and a certain entry becomes empty because data is picked or moved therefrom, data in an entry with a next priority order is moved to the empty entry immediately, thereby realizing storage of data in the order from an entry with a higher priority without empty entry. Further, the precedence matrix is a matrix in which the relationship of priority order of a certain entry with respect to other entries is recorded.

The data processing device such as the data buffer or the like generally includes output ports less than a plurality of entries. When a plurality of entries can be outputted, which entry among the plurality of entries can actually output data is decided by performing arbitration by priority encoders corresponding to the output ports. The priority encoders arbitrate, in the case where the number of circuit resources is limited and there are a plurality circuits requesting use of the circuit resources, which of the circuits takes the right of using the circuit resources.

The circuit of a priority encoder simultaneously arbitrating a plurality of output ports is more complicated than that of a priority encoder arbitrating only one output port, and thus causes an increases in circuit delay. For example, as illustrated in FIG. 20A, in a buffer capable of simultaneously outputting a plurality of pieces of data as an output A and an output B, the delay becomes large because an arbitration result about one of the output port for the output A and the output B is used to perform arbitration of the other output port.

Note that it is conceivable that as a configuration of a buffer capable of simultaneously outputting a plurality of pieces of data, a plurality of buffers each outputting only one piece of data are provided as illustrated in FIG. 20B. However, the buffering efficiency may decrease because only one of the buffer no longer has an empty entry earlier so that data is not inputted thereto or one of the buffer becomes empty so that only one piece of data is outputted at the same time. Further, when the buffer no longer has an empty entry, stagnation propagates to the upstream side on a transmission path, resulting in a decrease in throughput. This corresponds to a stall in a processor due to the reservation station connected to a blocking arithmetic unit occupied by one instruction in a plurality of cycles or head of line blocking in a network.

In Patent Document 1, there is proposed a reservation station using a bubble-up system of performing grouping of entries to reduce the number of entries which are arbitrated by one priority encoder. In Patent Document 2, there is proposed a reservation station performing arbitration of output ports for all of the entries by one arbitration circuit. It is also discussed that a signal permitting or inhibiting output from a specific output port is used in arbitration and decision of an output port. In Patent Document 3, there is proposed an instruction queue performing arbitration of output ports for all of the entries by one arbitration circuit using a precedence matrix. In Patent Document 4, there is proposed an instruction pick queue (unified pick queue) using an age matrix and there is a discussed example in which a slot number to be used in an instruction scheduling is allocated by a decoder and one instruction is picked per slot. In Non-Patent Document 1, an instruction issue queue (Unified Queue) composed of two queues using an age matrix is discussed. There is discussed mounting (implementation) of deciding which of the queues is used at a dispatch stage in which three different kinds of arithmetic pipelines are connected to one queue and one instruction is picked for each of the kinds of pipelines and three instructions at a maximum are simultaneously picked per one queue. In Patent Document 5, there is proposed an instruction issue queue using an age matrix and there is discussed a configuration having a latch circuit used for constituting the age matrix and enabling selective clock input.
Patent Document 1: Japanese Laid-open Patent Publication No. 2010-282668
Patent Document 2: Japanese Laid-open Patent Publication No. 2011-8732
Patent Document 3: U.S. Pat. No. 5,745,726
Patent Document 4: U.S. Laid-open Patent Publication No. 2011/0078697
Patent Document 5: U.S. Laid-open Patent Publication No. 2011/0185159
Non-Patent Document 1: “IBM POWER7 multicore server processor”, IBM J. RES. & DEV., VOL. 55, NO. 3, PAPER 1, MAY/JUNE 2011

### SUMMARY

One aspect of a data processing device includes: a plurality of entries; a plurality of output ports; an allocation unit that allocates the plurality of entries to a plurality of arbitration groups corresponding to the plurality of output ports respectively when a clock is inputted thereto; a port arbitration unit that performs arbitration of the output ports for each of the allocated arbitration groups when data held in the entry is outputted from the output port; and an output unit that outputs data held in the entry according to an arbitration result by the port arbitration unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processing system;

FIG. 2 is a diagram illustrating a configuration example of a processor in an embodiment;

FIG. 3 is a schematic diagram illustrating a configuration example of an instruction issue control unit in this embodiment;

FIG. 4 is a diagram illustrating a configuration example of the instruction issue control unit using a data processing device according to a first embodiment;

FIG. 5 is a diagram for explaining a precedence matrix in the first embodiment;

FIG. 6 is a diagram illustrating a circuit configuration example of a priority order determination unit in the first embodiment;

FIG. 7 is a diagram illustrating an example of grouping entries in the first embodiment;

FIG. 8A is a diagram illustrating another example of grouping entries in the first embodiment;

FIG. 8B and FIG. 8C are diagrams illustrating circuit configuration examples performing the grouping illustrated in FIG. 8A;

FIG. 9 is a diagram illustrating another example of a grouping circuit in the first embodiment;

FIG. 10 is a diagram illustrating an example of a group decision circuit in the first embodiment;

FIG. 11 is a diagram illustrating a circuit configuration example of a pick propriety setting unit in the first embodiment;

FIG. 12A and FIG. 12B are diagrams illustrating circuit configuration examples of an output enable port designation unit in the first embodiment;

FIG. 13 is a diagram illustrating a circuit configuration example of a port arbitration unit in the first embodiment;

FIG. 14 is a diagram illustrating a configuration example of the port arbitration unit in the first embodiment;

FIG. 15 is a diagram illustrating another configuration example of the group decision circuit in the first embodiment;

FIG. 16 is a diagram illustrating a configuration example of an instruction issue control unit using a data processing device according to a second embodiment;

FIG. 17 is a diagram illustrating a circuit configuration example of a port arbitration unit in the second embodiment;

FIG. 18 is a diagram illustrating a configuration example of the port arbitration unit in the second embodiment;

FIG. 19 is a diagram illustrating a configuration example of the port arbitration unit in the second embodiment; and

FIG. 20A and FIG. 20B are diagrams illustrating examples of buffers capable of simultaneously outputting a plurality of pieces of data.

### DESCRIPTION OF EMBODIMENTS

Hereinafter, a preferred embodiment will be explained with reference to accompanying drawings.

### First Embodiment

A first embodiment will be explained.

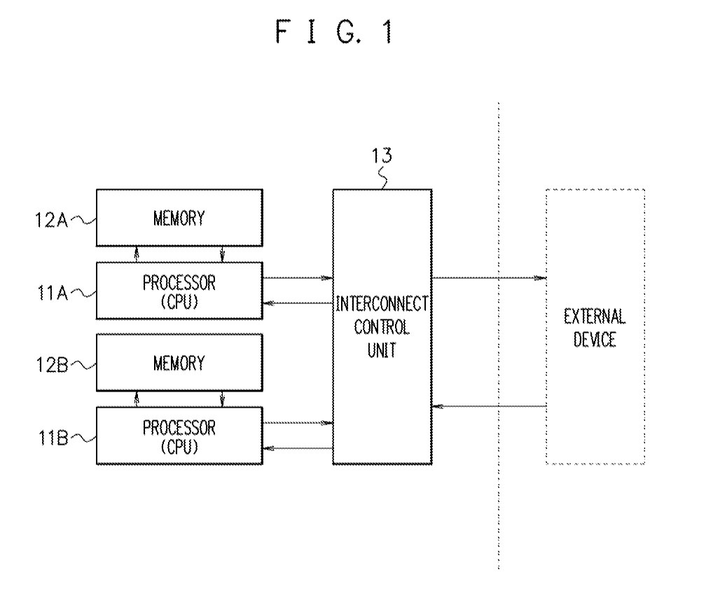

FIG. 1 is a diagram illustrating a configuration example of a processing system including a processor as an arithmetic processing device. The processing system illustrated in FIG. 1 has, for example, a plurality of processors 11A, 118 and memories 12A, 12B, and an interconnect control unit 13 that controls input/output to/from an external device. For example, the processors 11A, 11B have data processing devices according to the first embodiment therein.

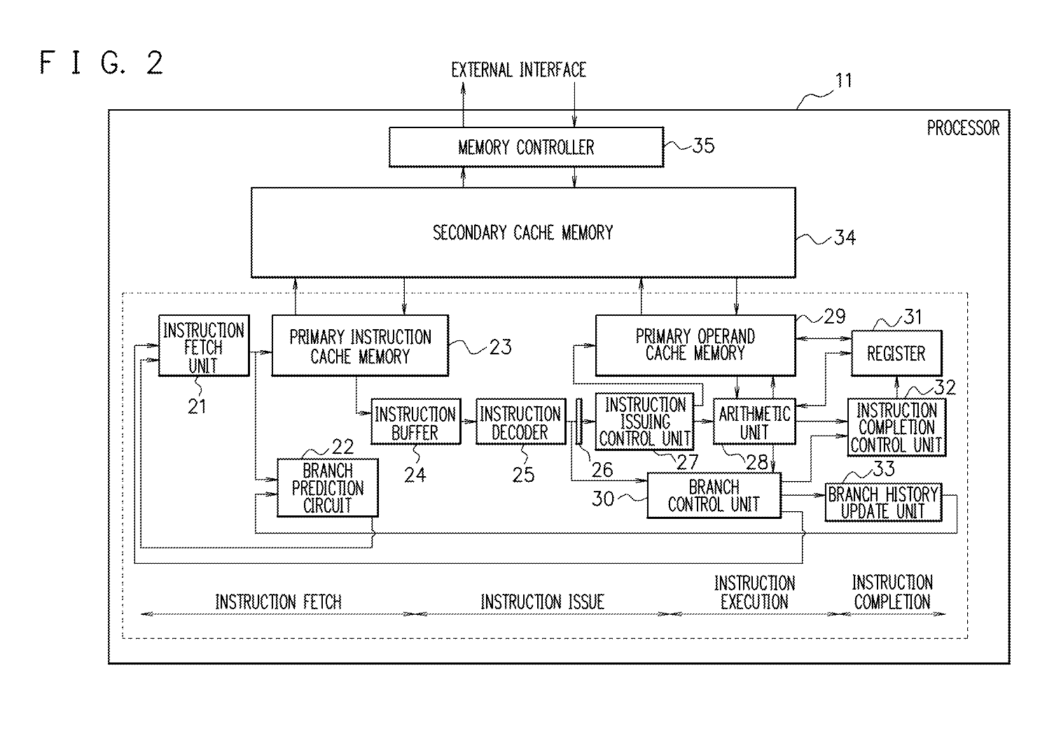

FIG. 2 is a diagram illustrating a configuration example of the processor 11 in this embodiment. The processor 11 in this embodiment has, for example, functions of out-of-order execution and pipeline processing of an instruction.

At an instruction fetch stage, an instruction fetch unit 21, an instruction buffer 24, a branch prediction circuit 22, a primary instruction cache memory 23, a secondary cache memory 34 and so on operate. The instruction fetch unit 21 receives a predicted branch target address of an instruction fetched, from the branch prediction circuit 22, a branch target address decided by branch operation from a branch control unit 30 and so on. The instruction fetch unit 21 selects one address from among the received predicted branch target address and branch target address, a next address generated in the instruction fetch unit 21 and continuing to the instruction fetched when there is no branch and so on, and decides a next instruction fetch address. The instruction fetch unit 21 outputs the decided instruction fetch address to the primary instruction cache memory 23 to fetch an instruction code corresponding to the outputted decided instruction fetch address.

The primary instruction cache memory 23 stores part of data in the secondary cache memory 34, and the secondary cache memory 34 stores part of data in a memory accessible via a memory controller 35. When there is no data on the relevant address in the primary instruction cache memory 23, the data is fetched from the secondary cache memory 34, and when there is no relevant data in the secondary cache memory 34, the data is fetched from the memory. In this embodiment, since the memory is arranged outside the processor 11, the control of input/output from/to the memory arranged outside is performed via the memory controller 35. The instruction code fetched from the relevant address in the primary instruction cache memory 23, the secondary cache memory 34, or the memory is stored in the instruction buffer 24.

The branch prediction circuit 22 receives the instruction fetch address outputted from the instruction fetch unit 21 and executes branch prediction in parallel with the instruction fetch.

The branch prediction circuit 22 performs branch prediction based on the received instruction fetch address and returns a branch direction indicating whether branch is taken or not taken and the predicted branch target address to the instruction fetch unit 21. When the predicted branch direction is “taken,” the instruction fetch unit 21 selects the branch target address predicted as the next instruction fetch address.

At an instruction issue stage, an instruction decoder 25 and an instruction issue control unit 27 operate. The instruction decoder 25 receives the instruction code from the instruction buffer 24 and analyzes the kind of the instruction, necessary execution resources and so on, and outputs an analysis result to the instruction issue control unit 27 via a latch unit 26 having a plurality of entries. The instruction issue control unit 27 has the structure of a reservation station. The instruction issue control unit 27 refers to dependencies of registers and the like referred to for the instruction and determines whether the execution resources can execute the instruction based on the update status of the register on the dependency and the execution status of an instruction using the same execution resources and so on. When determined that the execution resources can execute the instruction, the instruction issue control unit 27 outputs information required for execution of the instruction such as a register number, an operand address and so on to the execution resources. The instruction issue control unit 27 further has a function of a buffer storing the instruction until it becomes executable.

At an instruction execution stage, execution resources such as an arithmetic unit 28, a primary operand cache memory 29, a branch control unit 30 and so on operate. The arithmetic unit 28 receives data from a register 31 and/or the primary operand cache memory 29, executes arithmetic operations corresponding to the instruction, such as four basic arithmetic operations, logical operation, trigonometric function operation, address calculation and so on, and outputs an execution result to the register 31 and/or the primary operand cache memory 29. The primary operand cache memory 29 stores part of data in the secondary cache memory 34 as in the primary instruction cache memory 23. The primary operand cache memory 29 is used for loading data from the memory to the arithmetic unit 28 and/or the register 31 according to a load instruction, storing data from the arithmetic unit 28 or the register 31 to the memory according to a store instruction and so on. Each of the execution resources outputs a completion notification of instruction execution to an instruction completion control unit 32.

The branch control unit 30 receives the kind of the branch instruction from the instruction decoder 25, receives the branch target address and the result of arithmetic operations being a branch condition from the arithmetic unit 28. And the branch control unit 30 determines that branch is taken when the arithmetic result satisfies the branch condition or that branch is not taken when the arithmetic result does not satisfy the branch condition to thereby decide the branch direction. Further, the branch control unit 30 also performs determination whether the arithmetic result matches the branch target address and the branch direction at branch prediction, and control of an ordering between branch instructions. The branch control unit 30 outputs a completion notification of the branch instruction to the instruction completion control unit 32 when the arithmetic result matches the prediction. On the other hand, when the arithmetic result does not match the prediction, which is a failure of the branch prediction, the branch control unit 30 outputs the completion notification of the branch instruction and cancel of a subsequent instruction and an instruction refetch request to the instruction completion control unit 32.

At an instruction completion stage, the instruction completion control unit 32, the register 31, and a branch history update unit 33 operate. The instruction completion control unit 32 performs instruction completion processing in the order of instruction code stored in a commit stack entry based on the completion notification received from each of the execution resources for the instruction, and outputs an update direction to the register 31. Upon reception of the register update direction from the instruction completion control unit 32, the register 31 executes update of the register based on data on the arithmetic result received from the arithmetic unit 28 or the primary operand cache memory 29. The branch history update unit 33 creates history update data on branch prediction based on the result of the branch operation received from the branch control unit 30, and outputs the history update data to the branch prediction circuit 22.

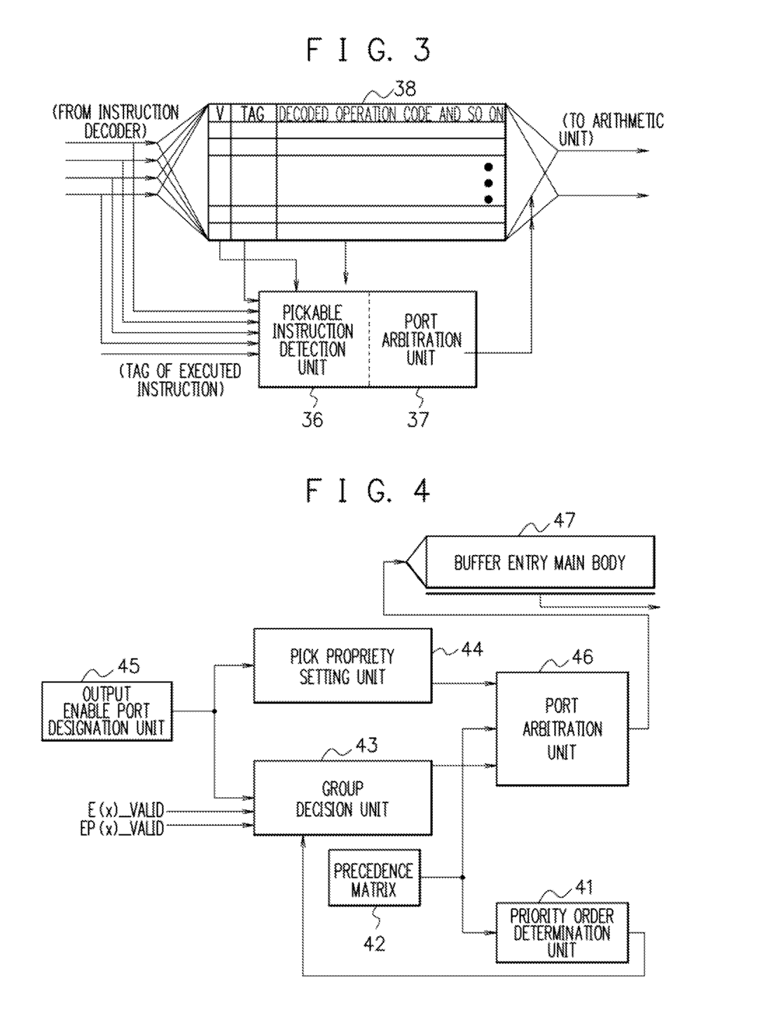

FIG. 3 is a schematic diagram illustrating a configuration example of the instruction issue control unit 27 illustrated in FIG. 2. FIG. 3 illustrates a configuration example of the instruction issue control unit 27 that realizes the function of the reservation station. The instruction issue control unit 27 illustrated in FIG. 3 has a plurality of output ports and can simultaneously output a plurality of instructions by outputting one instruction from each of the output ports. FIG. 3 illustrates an example having two output ports.

The instruction decoded by the instruction decoder is registered in an empty entry of an entry main body 38 of the reservation station. The contents to be registered are a valid bit (V) indicating that the entry is valid, a tag identifying an instruction operand of a destination register or the like in the instruction, a decoded operation code and so on. When the instruction registered in the entry of the reservation station is analyzed about the register dependency with a preceding instruction based on the tag and so on of an executed instruction and determined to be executable by a pickable instruction detection unit 36, the instruction is detected as an instruction pickable from the entry. The pickable instruction is subjected to arbitration of the output ports by a port arbitration unit 37, and an instruction decided to be outputted as a result of the arbitration is sent to the arithmetic unit. Note that it is also possible to enable the instruction to pass through the reservation station with a latency of one clock cycle by providing a bypass from the instruction decoder to the pickable instruction detection unit 36 for allowing information relating to the instruction to pass therethrough.

FIG. 4 is a diagram illustrating a configuration example of the instruction issue control unit 27 using the data processing device according to the first embodiment. The instruction issue control unit 27 illustrated in FIG. 4 has a priority order determination unit 41, a precedence matrix 42, a group decision unit 43, a pick propriety setting unit 44, an output enable port designation unit 45, a port arbitration unit 46, and a buffer entry main body 47. The priority order determination unit 41, the precedence matrix 42, the group decision unit 43, the pick propriety setting unit 44, and the output enable port designation unit 45 are included in the pickable instruction detection unit 36 illustrated in FIG. 3. Further, the port arbitration unit 46 corresponds to the port arbitration unit 37 illustrated in FIG. 3, and the buffer entry main body 47 corresponds to the entry main body 38 of the reservation station illustrated in FIG. 3.

The instruction issue control unit 27 in this embodiment groups the entries of the buffer entry main body 47 in each clock cycle at the timing of one clock cycle before the issue of the instruction. More specifically, before the arbitration of the output ports (one clock cycle before the issue of the instruction), the group decision unit 43 groups the entries into the number of output ports. The arbitration of the output ports by the port arbitration unit 46 is performed in each of the groups. For example, when there are two output ports which are a port A and a port B, the entries are allocated to the group A or the group B, and arbitration of the output ports is performed among the entries in the group A and among the entries in the group B. Note that the grouping of the entries is preferably performed so that the number of entries belonging to each group is even as much as possible.

Note that the case where the instruction issue control unit 27 has the two output port A and output port B as the output ports will be explained below as one example, and the instruction issue control unit 27 can be expandable to a case of having three or more output ports by using a unique signal for each arbitration group. Further, it is assumed that in the following explanation that the total number of entries of the buffer entry main body 47 is m, and an “entry n” indicates one arbitrary entry among an entry 0 to an entry (m−1).

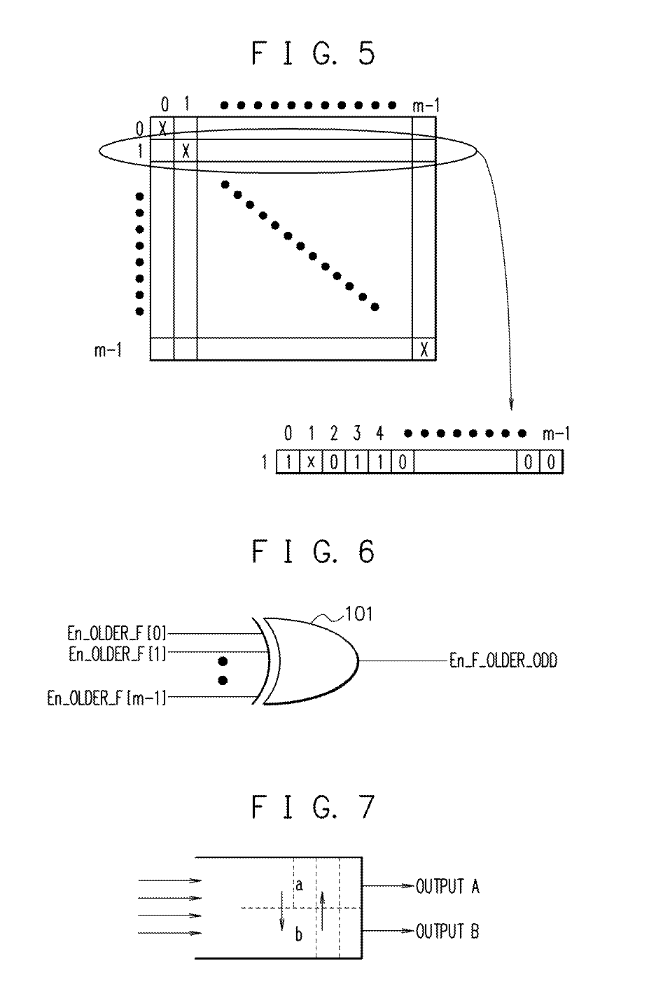

The priority order determination unit 41 determines whether the priority order of an entry is an odd order or an even order based on the precedence matrix 42 indicating the priority order relationship among the entries of the buffer entry main body 47. The precedence matrix 42 stores information indicating whether each entry is higher or lower in priority than each of other entries as illustrated in FIG. 5. In the example illustrated in FIG. 5, a bit of a flag OLDER_F of an entry older (higher in priority) than the self entry is raised (value 1), and a bit of a flag OLDER_F of an entry newer (lower in priority) than the self entry is not raised (value 0). For example, entries 0, 3, 4 are higher in priority than an entry 1 in FIG. 5.

The priority order determination unit 41 determines the priority order of the self entry based on the number of raised bits of a flag E(x)_OLDER_F. FIG. 6 is a diagram illustrating a circuit configuration example of the priority order determination unit 41. The priority order determination unit 41 has a circuit illustrated in FIG. 6 for each entry. The priority order determination unit 41 has an exclusive logical sum operation circuit (EXOR circuit) 101. The EXOR circuit 101 receives input of signals En_OLDER_F[0] to En_OLDER_F[m−1], and outputs an arithmetic result thereof as a signal En_F_OLDER_ODD.

The input signals En_OLDER_F[0] to En_OLDER_F[m−1] are signals indicating whether (m−1) entries except an entry n from the entry 0 to the entry (m−1) are higher or lower in priority than the entry n respectively. The input signals En_OLDER_F[0] to En_OLDER_F[m−1] are signals based on a flag OLDER_F of the precedence matrix 42. For example, the input signal En_OLDER_F[1] is set to “1” when the entry 1 is higher in priority than the entry n and set to “0” when the entry 1 is lower in priority than the entry n. Therefore, the number of signals set to “1” among the (m−1) signals En_OLDER_F[0] to En_OLDER_F[m−1] is the number of entries higher in priority than the entry n.

The output signal En_F_OLDER_ODD is a signal indicating that the number of the entries higher in priority than the entry n at the arbitration of the output ports is odd, namely, that the priority order of the entry n is even. As described above, by XORing (m−1) signals of the input signals En_OLDER_F[0] to En_OLDER_F[m−1], it is determined whether the priority order of the entry n is an even order or an odd order.

The group decision unit 43 groups the entries of the buffer entry main body 47 based on the output of the priority order determination unit 41. The group decision unit 43 groups the entries into a group of even orders and a group of odd orders based on the output signal En_F_OLDER_ODD of the priority order determination unit 41. Hereinafter, allocation of the entries with even orders as the priority orders to the group B and the entries with odd orders to the group A will be explained. Note that the allocation to the group A and the group B is for convenience of explanation and it is needless to say that their correspondence relationship may be reversed. In the above manner, m entries of the buffer entry main body 47 can be divided into the two groups A, B as illustrated in FIG. 7.

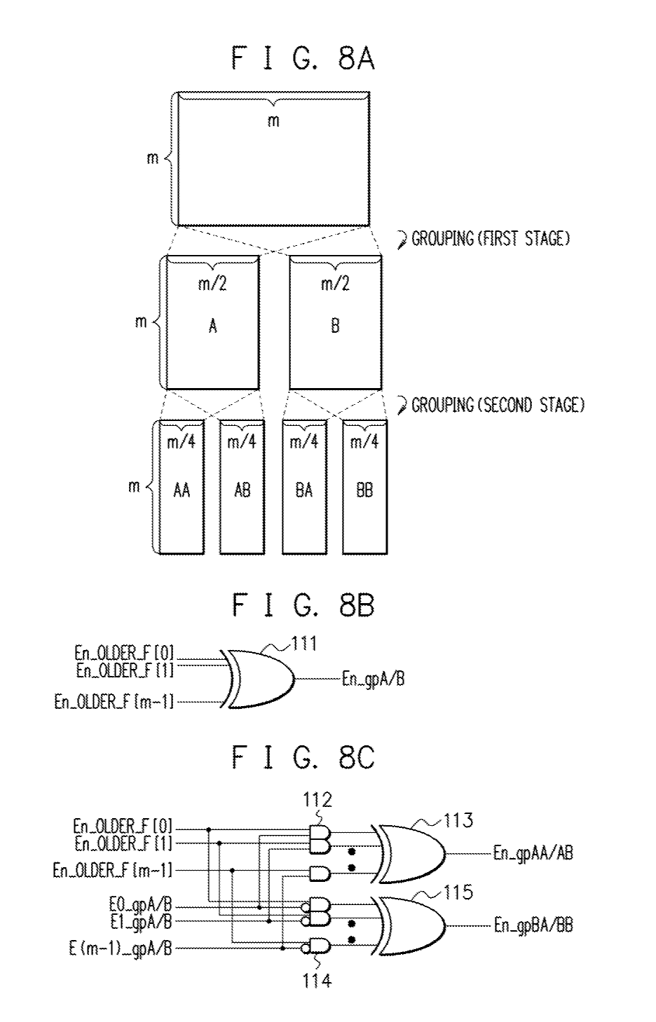

Note that m entries of the buffer entry main body 47 are divided into the two groups in the above explanation, and can also be divided into four groups. For example, the number of output ports is three or four, it is performed to apply division into four groups. When dividing m entries into the four groups, it is performed a first stage of grouping of division into the group A and the group B as in the above-described division into two groups, and further a second stage of grouping for each of the group A and the group B as illustrated in FIG. 8A. This makes it possible to divide m entries into four groups of a group AA, a group AB, a group BA, and a group BB. Note that when the number of the output ports is three, it is performed to make any two of the groups correspond to one output port.

FIG. 8B and FIG. 8C are diagrams illustrating configuration examples of circuits for dividing m entries into four groups. In FIG. 8B, an EXOR circuit 111 receives input of signals En_OLDER_F[0] to En_OLDER_F[m−1], and outputs an arithmetic result thereof as a signal En_gpA/B. In FIG. 8C, a logical product operation circuit (AND circuit) 112 receives input of a signal En_OLDER_F[1] (i is a subscript and i=0 to m−1, except n) and a signal Ei_gpA/B. An EXOR circuit 113 receives input of the output of the AND circuit 112, and outputs an arithmetic result thereof as a signal En_gpAA/AB. Further, an AND circuit 114 receives input of a signal En_OLDER_F[i] and a negative logic signal of the signal Ei_gpA/B. An EXOR circuit 115 receives input of the output of the AND circuit 114, and outputs an arithmetic result thereof as a signal En_gpBA/BB.

In FIG. 8B and FIG. 8C, the input signals En_OLDER_F[0] to En_OLDER_F[m−1] are signals indicating whether (m−1) entries except the entry n from the entry 0 to the entry (m−1) are higher in priority than the entry n respectively. Further, the signal En_gpA/B is a signal indicating which group the entry n belongs to, the group A or the group B. Similarly, the signal En_gpAA/AB is a signal indicating which group the entry n belongs to, the group AA or the group AB, and the signal En_gpBA/BB is a signal indicating which group the entry n belongs to, the group BA or the group BB.

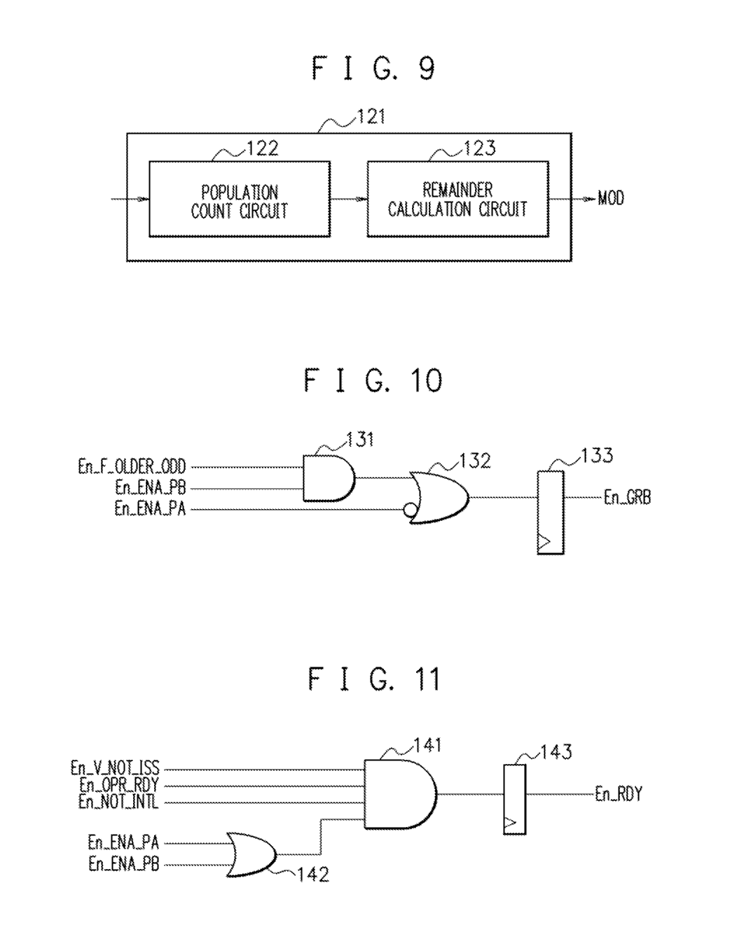

Similarly, the grouping into the number of power-of-two such as 8, 16, 32 . . . can be handled by a three-, four-, five- . . . stage configuration. Further, by using a grouping circuit 121 as illustrated in FIG. 9, a population count circuit 122 counts the number of signals with “1” among the signals En_OLDER_F[0] to En_OLDER_F[m−1] and a remainder calculation circuit 123 calculates a remainder MOD when the counted value is divided by n. Then, grouping according to the value of the remainder MOD enables division of m entries into arbitrary n groups.

Here, in the example of the above-described grouping, even when it is prohibited to output the data in an entry from a specific output port, grouping is performed without distinction. However, when a certain entry is grouped into an arbitration group corresponding to the output port prohibited to output data, the entry even with the highest priority comes to wait in the buffer, resulting in a decrease in buffering efficiency.

Hence, when it is prohibited to use the specific output port, a circuit as illustrated in FIG. 10 is used to perform grouping to prevent use of the output port, thereby preventing the decreased in buffering efficiency. FIG. 10 is a diagram illustrating a configuration example of the group decision circuit preventing the content buffered in the entry n from being outputted from the specific output port. FIG. 10 illustrates a case of having two output port A and output B as output ports as an example.

The group decision circuit illustrated in FIG. 10 has an AND circuit 131, a logical sum operation circuit (OR circuit) 132, and a latch 133. To the AND circuit 131, the signal En_F_OLDER_ODD and a signal En_ENA_PB are inputted. The OR circuit 132 receives input of the output of the AND circuit 131, a negative logic signal of a signal En_ENA_PA, and outputs an arithmetic result thereof as a signal En_GRB via the latch 133. The input signal En_F_OLDER_ODD is a signal indicating that when the content of the entry n can be outputted from any port, as a result of the grouping logic at the preceding stage, the entry n is grouped into the group B. The input signal En_ENA_PA is a signal permitting the entry n to be picked for the output port A, and the input signal En_ENA_PB is a signal permitting the entry n to be picked for the output port B. The input signals En_ENA_PA, En_ENA_PB are outputted from the later-described output enable port designation unit 45 and set to “1” when permitting the entry n to be picked for the corresponding output port. The output signal En_GRB is a signal setting that the arbitration group of the entry n is included in the group B. Note that the position of the latch 133 is not limited to this.

The group decision circuit illustrated in FIG. 10 outputs the input signal En_F_OLDER_ODD as the output signal En_GRB when the entry n is not limited to any output port. Further, when it is prohibited to output the entry n from the output A, the group decision circuit outputs the outputs signal En_GRB (value “1”) allocating the entry n to the group B regardless of the input signal En_F_OLDER_ODD. Further, when it is prohibited to output the entry n from the output port B, the group decision circuit outputs the outputs signal En_GRB (value “0”) allocating the entry n to the group A regardless of the input signal En_F_OLDER_ODD.

Returning to FIG. 4, the pick propriety setting unit 44 sets that the entry is in a pickable state. FIG. 11 is a diagram illustrating a circuit configuration example of the pick propriety setting unit 44. FIG. 11 illustrates a circuit corresponding to the entry n. The pick propriety setting unit 44 has an AND circuit 141, an OR circuit 142, and a latch 143. The AND circuit 141 receives input of a signal En_V_NOT_ISS, a signal En_OPR_RDY, a signal En_NOT_INTL and the output of the OR circuit 142, and outputs an arithmetic result thereof as a signal En_PDY via the latch 143. Into the OR circuit 142, the signal En_ENA_PA and the signal En_ENA_PB are inputted.

The input signal En_V_NOT_ISS indicates that the entry n is valid and in a state not picked from the buffer entry main body 47 (reservation station). The input signal En_OPR_RDY indicates that all of the operands of the instruction buffered in the entry n are ready or all of them are in a state capable of being outputted. In other words, the execution of the preceding instruction in the register dependency has ended and the arithmetic unit and so on are in a state capable of using the operands.

The input signal En_NOT_INTL is a signal indicating negation of a state that the picking of the entry n is impossible. Note that the signal En_NOT_INTL may be “1” at all times. The signal En_NOT_INTL is used in the case where issue of the data (instruction) buffered in the entry n is suppressed. That is, for example, a case where a processor having a configuration of reading operands of an instruction from a register after the issue of the instruction is in a state that the operands of the instruction cannot be read from the register. Another example is, for example, a case where the kinds of registers from which the operands can be simultaneously read are limited because of the structure of the register file, and the operands of the instruction in the entry n correspond to the registers of the kinds from which the operands cannot be read. The case of limiting the kinds of registers which can be simultaneously read include, for example, a case of limiting, in hardware multi-threading, architecture registers which can be simultaneously read from a register file to any of the threads, a case of limiting, in a processor with an instruction set architecture with a register window, the registers which can be simultaneously read from a register file to the registers in the register window, and so on. In addition, examples of the case of suppressing issue of an instruction include the case of controlling the issue order among instructions not only by the register dependency but also by a designation of an instruction decoder.

The input signal En_ENA_PA is a signal outputted from the later-described output enable port designation unit 45 which is a signal permitting the entry n to be outputted from the output port A. Further, the input signal En_ENA_PB is a signal outputted from the later-described output enable port designation unit 45 which is a signal permitting the entry n to be outputted from the output port B.

The output signal En_RDY is a signal indicating that the entry n is a valid entry and is not picked from the buffer entry main body 47 yet, and the instruction is in a pickable state and can be picked for any output port. Note that the position of the latch 143 is an example and not limited to this.

The logic of setting that the entry is in a pickable state is an example of the case of using the data processing device in this embodiment as the instruction issue control unit (reservation station). Also in the case of using the data processing device in this embodiment for other than the reservation station, an arbitrary logic circuit which sets that the entry is in a pickable state can be configured according to the usage of the data processing device.

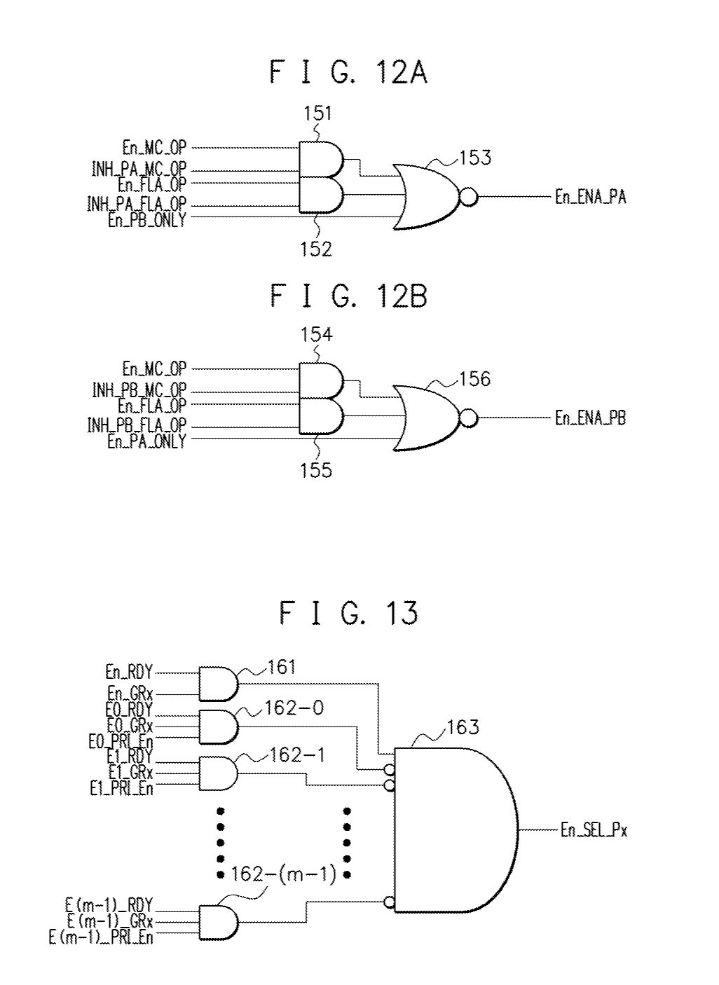

The output enable port designation unit 45 is for designating output enable output ports for each entry and permitting or inhibiting that the entry is picked for a specific output port. FIG. 12A and FIG. 12B are diagrams illustrating circuit configuration examples of the output enable port designation unit 45. FIG. 12A illustrates a circuit corresponding to the entry n regarding the output port A, and FIG. 12B illustrates a circuit corresponding to the entry n regarding the output port B.

As illustrated in FIG. 12A, the output enable port designation unit 45 has AND circuits 151, 152 and a negative logical sum operation circuit (NOR circuit) 153 regarding the output port A. Into the AND circuit 151, a signal En_MC_OP and a signal INH_PA_OP are inputted. Into the AND circuit 152, a signal En_FLA_OP and a signal INH_PA_FLA_OP are inputted. The NOR circuit 153 receives input of the outputs of the AND circuits 151, 152 and a signal En_PB_ONLY, and outputs an arithmetic result thereof as a signal En_ENA_PA.

As illustrated in FIG. 12B, the output enable port designation unit 45 has AND circuits 154, 155 and a NOR circuit 156 regarding the output port B. Into the AND circuit 154, the signal En_MC_OP and a signal INH_PB_MC_OP are inputted. Further, into the AND circuit 155, the signal En_FLA_OP and a signal INH_PB_FLA_OP are inputted. The NOR circuit 156 receives input of the outputs of the AND circuits 154, 155 and a signal En_PA_ONLY, and outputs an arithmetic result thereof as a signal En_ENA_PB.

In FIG. 12A and FIG. 12B, the input signal En_MC_OP is a signal indicating that the instruction buffered in the entry n is an instruction continuously occupying the arithmetic unit for use in a plurality of cycles. The input signal INH_PA_MC_OP is a signal indicating that the arithmetic unit connected to the output port A has already been in use by the instruction occupying the arithmetic unit in a plurality of cycles and inhibiting a new instruction using the arithmetic unit from being picked for the output port A. A signal obtained by logical product operation of the signal En_MC_OP and the signal INH_PA_MC_OP is a signal inhibiting the instruction in the entry n from being picked for the output port A because the instruction buffered in the entry n is an instruction continuously occupying the arithmetic unit in a plurality of cycles and the arithmetic unit connected to the output port A has already been in use.

An input signal En_FLA_OP is a signal indicating that the instruction buffered in the entry n is an instruction using a pipelined arithmetic unit whose maximum number of output delay cycles is fixed. Here, that the maximum number of output delay cycles is fixed means that, for example, when the operation latency of the arithmetic unit is four cycles or six cycles, the latency can be predicted to be six cycles at a maximum before completion of the arithmetic operation. The input signal INH_PA_FLA_OP is a signal indicating that a transmission path for outputting an arithmetic result of an arithmetic unit connected to the output port A which is the pipelined arithmetic unit whose maximum number of output delay cycles is fixed is predicted to be used by another instruction, and inhibiting a new instruction using the arithmetic unit from being picked for the output port A. A signal obtained by logical product operation of the signal En_FLA_OP and the signal INH_PA_FLA_OP is a signal inhibiting the instruction in the entry n from being picked for the output port A because the instruction buffered in the entry n is an instruction using the pipelined arithmetic unit whose maximum number of output delay cycles is fixed and whose transmission path for outputting an arithmetic result thereof is predicted to be used by another instruction.

An input signal En_PB_ONLY is a signal indicating that the instruction buffered in the entry n is an instruction using an arithmetic unit connected only to the output port B and inhibiting the instruction from being picked for other than the output port B.

The output signal En_ENA_PA is a signal permitting the instruction buffered in the entry n to be picked for the output port A.

Note that the signals illustrated in FIG. 12B correspond to those obtained by replacing the output port A and the output B for the above-described signals illustrated in FIG. 12A.

An example of the case where a transmission path for outputting a result of a certain arithmetic unit is used by another instruction includes a case where there are a plurality of kinds of arithmetic units and their latencies are different from each other. When it is decided in advance that the transmission path for outputting the result of an arithmetic unit with a small latency used by a subsequent instruction is used for outputting the result of an arithmetic unit with a large latency used by a preceding instruction, control is performed to inhibit the output of the subsequent instruction to the output port connected to the arithmetic unit using the transmission path. The above-described signals En_MC_OP, En_FLA_OP, En_PA_ONLY, En_PB_ONLY are signals instructing control at execution of the instruction different depending on the kind of the instruction, and are sent from the instruction decoder. To configure a reservation station in which an instruction is registered in the entry from the pipeline stage at the preceding stage and then can pass therethrough with a latency of one cycle, a bypass path as illustrated in FIG. 3 is provided immediately before the signals in some cases.

The logic of designating the output port capable outputting the above-described entry is an example of the case of using the data processing device in this embodiment for the instruction issue control unit (reservation station). Also in the case of using the data processing device in this embodiment for other than the reservation station, an arbitrary logic circuit that designates a port capable of outputting the entry can be configured according to the usage of the data processing device.

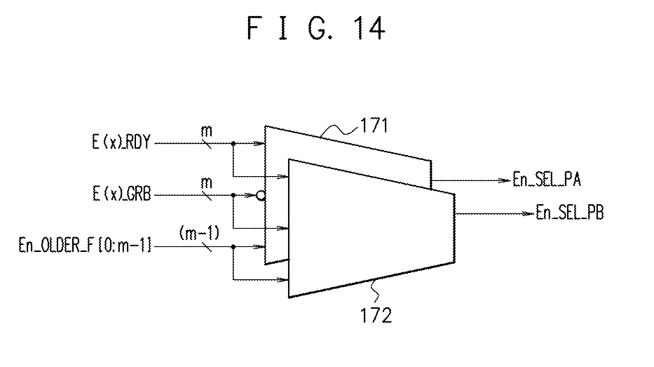

The port arbitration unit 46 performs arbitration of the output ports for each group based on the result of the grouping by the group decision unit 43. FIG. 13 is a diagram illustrating a circuit configuration example of the port arbitration unit 46. FIG. 13 illustrates a circuit (priority encoder for the entry n) corresponding to the entry n for an arbitrary output port x. The port arbitration unit 46 has AND circuits 161, 162-i, 163. Into the AND circuit 161, a signal En_RDY and a signal En_GRx are inputted. Further, into the AND circuit 162-i, a signal Ei_RDY, a signal Ei_GPx, and a signal Ei_PRI_En are inputted. The AND circuit 163 receives input of the output of the AND circuit 161 and a negative logic signal of the output of the AND circuit 162-i, and outputs an arithmetic result thereof as a signal En_SEL_Px.

The input signal En_RDY is a signal indicating that the entry n is in a state capable of being outputted. The input signal Ei_RDY is a signal indicating that each of entries i is in a state capable of being outputted, and there are (m−1) signals. If there is no need to enable setting of a waiting state for each entry depending on the usage of the data processing device, the signal may be “1” at all times.

The input signal En_GRx is a signal indicating whether the entry n belongs to an arbitration group x. The signal Ei_GRx is a signal indicating whether each of entries i belongs to an arbitration group x, and there are (n−1) signals.

The input signal Ei_PRI_En is a signal indicating that the priority of the entry i is higher than the priority of the entry n, and there are (m−1) signals. The case where all of the (m−1) input signals Ei_PRI_En are “0” indicates that the priority of the entry n is highest. Note that the signal En_PRI_En corresponding to the entry n may or may not exist, and does not exist in this example.

The circuit illustrated in FIG. 13 outputs the signal. En_SEL_Px indicating that the entry n is outputted from the output port x when the entry n is in a state capable of being outputted, the entry n belongs to the arbitration group x, and there is no entry having a priority higher than the priority of the entry n.

FIG. 14 is a diagram illustrating a configuration example of the port arbitration unit 46 when the number of output ports is two, and illustrating an example of the port arbitration unit 46 using the priority encoder for the entry n illustrated in FIG. 13.

An input signal E(i)_RDY is a signal indicating that the entry i is in a state capable of being outputted, and there are m signals. Further, an input signal E(i)_GRB is a signal indicating whether the entry i belongs to the group B, and there are m signals. In this example, the entry not belonging to the arbitration group B belongs to the arbitration group A. An input signal En_OLDER_F[0: (m−1)] is a signal indicating that the priority of the entry n is higher than the priorities of the entries except n among numbers 0 to (m−1), and there are (m−1) signals. Note that a signal En_OLDER_F[n] may or may not exist. The input signal En_OLDER_F[0: (m−1)] is connected to the signal E(i)_PRI_En inside the priority encoder explained with FIG. 13. For example, a signal En_OLDER_F[0] is connected to a signal E0_PRI_En and a signal En_OLDER_F[1] is connected to a signal E1_PRI_En.

A priority encoder 171 for the entry n for the group A receives the signal E(i)_RDY, a negative logic signal of the signal E(i)_GRB, and the signal En_OLDER_{—}[0: (m−1)] and performs arbitration whether to output the entry n from the output port A. An output signal En_SEL_PA outputted from the priority encoder 171 is a result of the arbitration and indicates that the entry n is outputted from the output port A.

Similarly, a priority encoder 172 for the entry n for the group B receives the signal E(i)_RDY, the signal E(i)_GRB, and the signal En_OLDER_F[0:(m−1)] and performs arbitration whether to output the entry n from the output port B. An output signal En_SEL_PB outputted from the priority encoder 172 is a result of the arbitration and indicates that the entry n is outputted from the output port B.

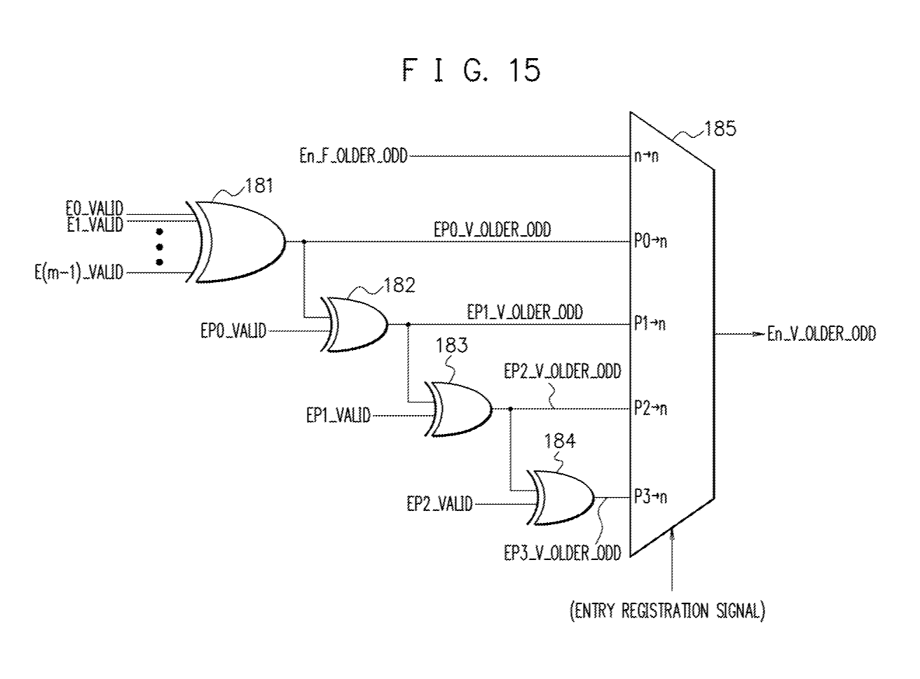

Here, in a (simply mounting in) simple implementation of the grouping system using the precedence matrix, the value of the precedence matrix itself is unavailable (not reflected) yet in a cycle in which the entry is registered in the buffer, so that the information on the priority order is not reflected in the grouping before the next cycle. Use of the circuit illustrated in FIG. 15 enables appropriate grouping in which signals used for grouping bypasses the entry main body at registration in the entry in the buffer to pass the buffer with a shortest latency.

FIG. 15 is a diagram illustrating a configuration example of a decision circuit of an appropriate arbitration group when enabling passage through the buffer with a latency of one clock cycle. The decision circuit of the arbitration group illustrated in FIG. 15 performs grouping in consideration of the signal En_F_OLDER_ODD indicating whether the priority of the entry n at the arbitration of the output ports is an even order, and the entry (entry of a latch unit 26) waiting at the pipeline stage preceding one cycle to the buffer.

An example of the case where there are waiting entries P0, P1, P2, P3 in the latch unit 26 is illustrated. The subsequent stage is an entry 0 to an entry (m−1) of the buffer entry main body 47. The priority is highest for the entry PG and descends in the order of the entries P0, P1, P2, P3, and never changes when moving to the subsequent stage. Any of the entries P0, P1, P2, P3 is lower in priority than any of the entry 0 to the entry (m−1). The latch unit 26 being the preceding stage is not always to have four entries.

The input signal En_F_OLDER_ODD is a signal indicating whether the priority order of the entry n at the arbitration of the output ports is an even order. Input signals E0_VALID to E(m−1)_VALID are signals indicating that contents are registered in the entry 0 to the entry (m−1) respectively, and there are m signals in total. An input signal EP0_VALID is a signal indicating that the content is registered in the entry P0 in the latch unit 26 at the preceding stage. Similarly, input signals EP1_VALID, EP2_VALID are signals indicating that the content is registered in the entries P1, P2 in the latch unit 26 at the preceding stage.

A signal EP0_V_OLDER_ODD outputted from an EXOR circuit 181 indicates whether the number of entries, among the entry 0 to the entry (m−1), higher in priority than the entry P0 is odd. In other words, the signal EP0_V_OLDER_ODD indicates that the priority order of the entry P0 is an even order. A signal EP1_V_OLDER_ODD outputted from an EXOR circuit 182 indicates whether the number of entries, among the entry 0 to the entry (m−1) and the entry P0, higher in priority than the entry P1 is odd. In other words, the signal EP1_V_OLDER_ODD indicates that the priority order of the entry P1 is an even order. A signal EP2_V_OLDER_ODD outputted from an EXOR circuit 183 indicates whether the number of entries, among the entry 0 to the entry (m−1) and the entries P0, P1, higher in priority than the entry P2 is odd. In other words, the signal EP2_V_OLDER_ODD indicates that the priority order of the entry P2 is an even order. A signal EP3_V_OLDER_ODD outputted from an EXOR circuit 184 indicates whether the number of entries, among the entry 0 to the entry (m−1) and the entries P0, P1, P2, higher in priority than the entry P3 is odd. In other words, the signal EP3_V_OLDER_ODD indicates that the priority order of the entry P3 is an even order.

An output signal En_V_OLDER_ODD outputted from a selector 185 is a signal indicating that the priority of the entry n at the arbitration of the output ports is an even order in consideration of the priority when a new content is registered therein. Here, the signal En_V_OLDER_ODD is a signal with a value selected from among those of the signals En_F_OLDER_ODD, EP0_V_OLDER_ODD, EP1_V_OLDER_ODD, EP2_V_OLDER_ODD, and EP3_V_OLDER_ODD by an entry registration signal. For example, when the content of the entry P2 is registered in the entry n, the value of the signal E2_V_OLDER_ODD is the value of the signal En_V_OLDER_ODD. Note that when a new entry is not registered, the value of the signal En_F_OLDER_ODD is the value of the signal En_V_OLDER_ODD.

Even if the time when the content of the entry stays in the buffer is only one clock cycle and it is immediately picked, the circuit illustrated in FIG. 15 can appropriately perform grouping so as to prevent deviation in number of entries included in a group among arbitration groups.

According to this embodiment, the following effects can be achieved.

The output port is not fixed even after registration in an entry in the buffer, so that the use efficiency of the buffer is increased and the throughput is improved. For example, the embodiment is effective for the case where the buffer used for a usage in which blocking that the output destination is occupied in a plurality of cycles frequently occurs and the output destination can be flexibly selected. Further, in this embodiment, since the port arbitration unit independently performs arbitration of each output port without using the arbitration results of other output ports, the delay relating to the arbitration is reduced.

Further, performing grouping in each cycle keeps the numbers of entries included in groups even to improve the buffering efficiency. Further, even when a certain output destination is blocked, an entry is possibly allocated to another group and can be expected to be outputted from another output destination. Further, performing grouping based on the priority order can prevent deviation in priority of each of the entries among groups, and pick from an entry with an approximately high priority can be expected as the whole buffer.

Note that though the precedence matrix is used in this embodiment, a buffer is applicable as long as it is in a form of holding information equivalent to the matrix of the priority order relationship among entries. For example, a buffer in which the information on the priority order relationship among entries is stored in a latch, memory or the like in a compressed form can also realize the similar function by performing grouping using information on the priority order.

### Second Embodiment

Next, a second embodiment will be explained.

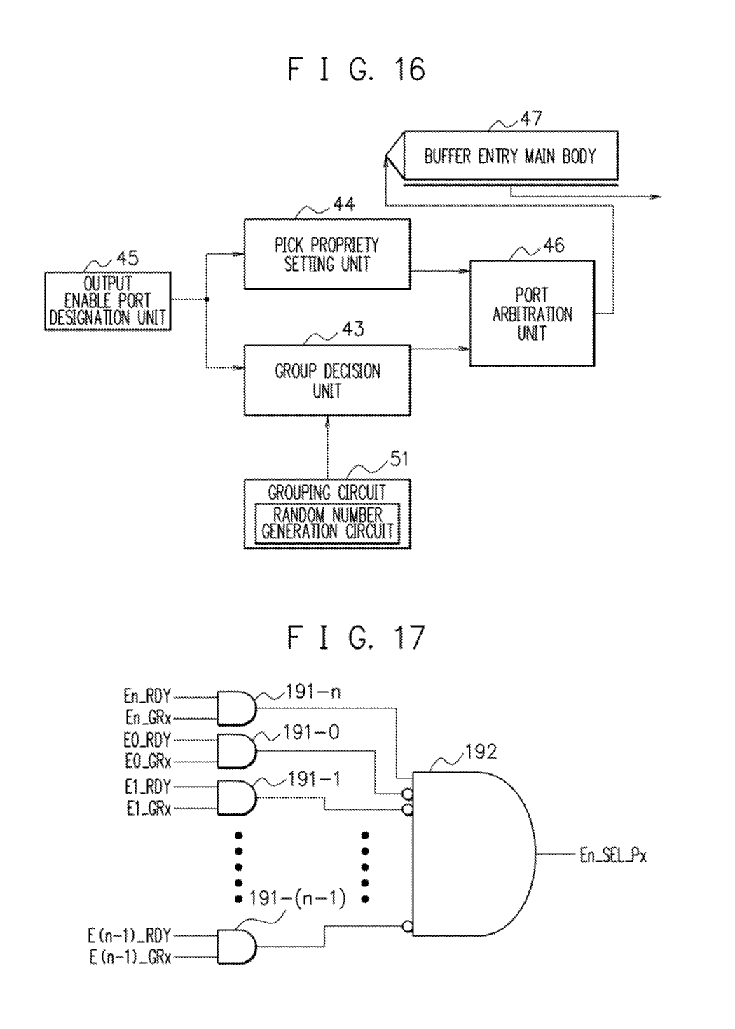

FIG. 16 is a diagram illustrating a configuration example of an instruction issue control unit using a data processing device according to the second embodiment. In FIG. 16, the same numerals are given to blocks having the same functions as those of the blocks illustrated in FIG. 4 and the overlapping description will be omitted.

The data processing device according to the second embodiment is configured such that a group decision unit 43 performs grouping arbitration groups of entries based on the output of a grouping circuit 51. The grouping circuit 51 has a random number generation circuit and so on. If the uniformity of random numbers generated by the random number generation circuit is sufficient, grouping without deviation can be expected.

As the random number generation circuit, a pseudo-random number generator using, for example, LFSR (Linear feedback shift register) is conceivable. Alternatively, as the seed value of the random number generation circuit, the priority of the entry or the entry number (in the case of the bubble-up system), a value variable in each cycle such as an appropriate counter value or the like is combined with the value unique to the entry such as data held in the entry or the like for use, whereby grouping with less deviation can be expected. For example, it is performed to use a hash value of the value varying in each cycle and the value unique to the entry.

The data processing device according to the second embodiment is also applicable to the case where the buffer does not use the precedence matrix but takes a form of the bubble-up system. In the case of the bubble-up system, the priority order relationship among the entries is fixed, so that the configuration of the port arbitration unit 46 can be simplified as illustrated in FIG. 17 to FIG. 19.

FIG. 17 is a diagram illustrating a circuit configuration example of the port arbitration unit 46 when using the buffer in the bubble-up system. FIG. 17 illustrates a circuit (priority encoder for the entry n) corresponding to the entry n for an arbitrary output port x. The port arbitration unit 46 has AND circuits 191-j (j=0 to n integer (positive integer)), 192. Into the AND circuit 191-j, a signal Ej_RDY and a signal Ej_GRx are inputted. The AND circuit 192 receives input of the output of the AND circuit 191-n and a negative logic signal of the output of the AND circuit 191-j (j≠n), and outputs an arithmetic result thereof as a signal En_SEL_Px. Note that the signals are the same as those illustrated in FIG. 13 and therefore the description thereof will be omitted.

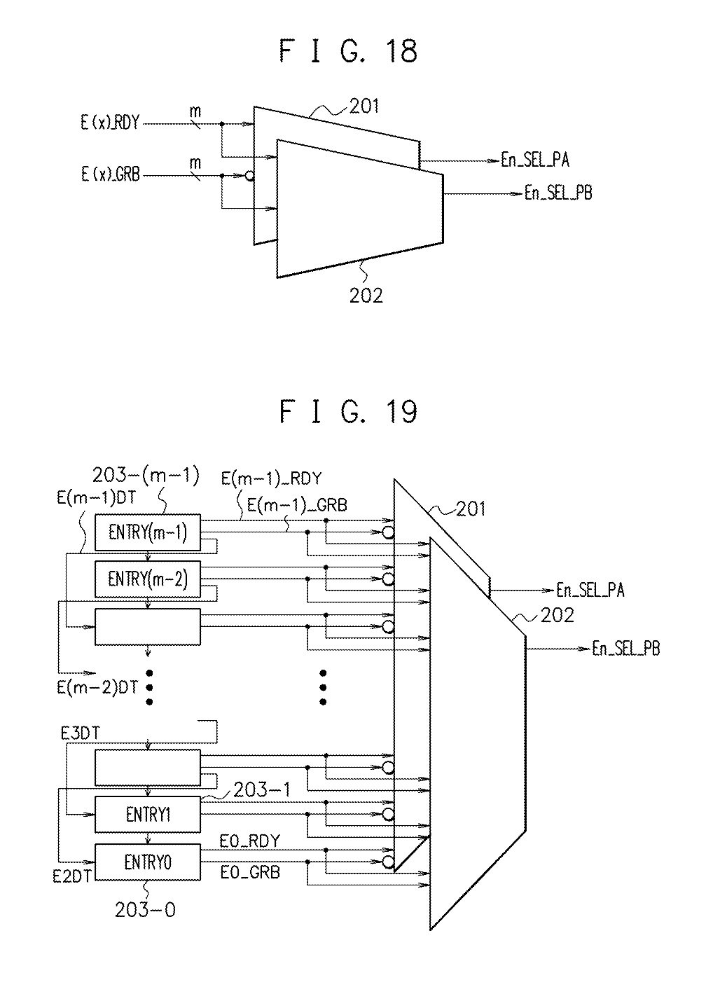

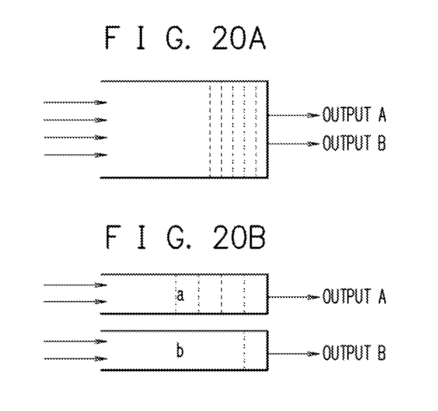

FIG. 18 is a diagram illustrating a configuration example of the port arbitration unit 46 in the case of using the buffer in the bubble-up system and when the number of the output ports is two, and illustrates an example of the port arbitration unit 46 using the priority encoder for the entry n illustrated in FIG. 17.

The input signal E(x)_RDY is a signal indicating that the entry 0 to the entry (m−1) are in a state capable of being outputted, and there are m signals. Further, the input signal. E(x)_GRB is a signal indicating whether the entry 0 to the entry (m−1) belong to the arbitration group B, and there are m signals. In this example, the entry not belong to the arbitration group B belongs to the arbitration group A. A priority encoder 201 for the entry n for the group A receives the signal E(x)_RDY and a negative logic signal of the signal E(x)_GRB and performs arbitration whether to output the entry n from the output port A. An output signal En_SEL_PA outputted from the priority encoder 201 is a result of the arbitration and indicates that the entry n is outputted from the output port A. Similarly, a priority encoder 202 for the entry n for the group B receives the signal E(x)_RDY and of the signal E(x)_GRB and performs arbitration whether to output the entry n from the output port B. An output signal En_SEL_PB outputted from the priority encoder 202 is a result of the arbitration and indicates that the entry n is outputted from the output port B. The relation between the signals and flow of data in the entries is illustrated in FIG. 19.

Note that though the data processing device is illustrated in the case in which it is applied to the instruction issue control unit is illustrated as an example in each of the above-described embodiments, the data processing device is not limited to this. The data processing device in each of the above-described embodiments can be used for a network switch or the like in the network permitting replacement of the orders of packets or when performing QoS (Quality of Service) control.

It is possible to suppress delay relating to arbitration of output ports.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing device comprising:
a plurality of entries;
a plurality of output ports;
an allocation unit that allocates the plurality of entries to a plurality of arbitration groups corresponding to the plurality of output ports respectively when a clock is inputted thereto;
a port arbitration unit that performs arbitration of the output ports for each of the allocated arbitration groups when data held in the entry is outputted from the output port; and
an output unit that outputs data held in the entry according to an arbitration result by the port arbitration unit.

2. The data processing device according to claim 1, further comprising:
an output propriety setting unit that sets whether the data held in each of the entries is in a state capable of being outputted.

3. The data processing device according to claim 1, further comprising:
a port designation unit that is capable of designating for each of the entries an output port from which data held in a corresponding entry is outputted, among the plurality of output ports.

4. The data processing device according to claim 1,
wherein the allocation unit comprises:
an order determination unit that determines a priority order of each of the entries based on priority order information indicating a priority order relationship among the plurality of entries; and
a group decision unit that allocates the plurality of entries into a plurality of arbitration groups respectively based on a result of determination determined by the order determination unit.

5. The data processing device according to claim 1,
wherein the allocation unit comprises:
a random number generation unit that generates random numbers corresponding to the entries respectively; and
a group decision unit that allocates the plurality of entries into a plurality of arbitration groups respectively based on the random numbers generated by the random number generation unit.

6. A method for controlling a data processing device having a plurality of entries and a plurality of output ports, the method comprising:
by an allocation unit included in the data processing device, allocating the plurality of entries to a plurality of arbitration groups corresponding to the plurality of output ports respectively when a clock is inputted thereto;
by a port arbitration unit included in the data processing device, arbitrating the output ports for each of the allocated arbitration groups when data held in the entry is outputted from the output port; and
by an output unit included in the data processing device, outputting data held in the entry according to an arbitration result by the port arbitration unit.
